(19) United States
(12) Patent Application Publication
(10) Pub. No.: US 2006/0148963 A1
(43) Pub. Date: Jul. 6, 2006

(54) Electrically conductive polymerized macrocyclic oligomer carbon nanofiber compositions

(76) Inventors: Robert P. Dion, Midland, MI (US); David H. Bank, Midland, MI (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/541,103

(22) PCT Filed: Dec. 19, 2003
(86) PCT No.: PCT/US03/40722

§ 371 Date: Aug. 17, 2005

Related U.S. Application Data
(60) Provisional application No. 60/436,400, filed on Dec. 23, 2002.

(51) Int. Cl. C08K 3/04; C09D 151/00

(52) U.S. Cl. 524/495; 523/201

(57) ABSTRACT

The invention relates to electrically conductive compositions comprising polymers derived from macrocyclic oligomers and carbon nanofibers. Also disclosed are molded articles comprising the electrically conductive compositions.

The invention relates to electrically conductive compositions comprising polymers derived from macrocyclic oligomers and carbon nanofibers. The invention also relates to processes for preparing such compositions. Furthermore, the invention relates to articles prepared from the compositions of the invention.

In order to improve the functionality and environmental impact of large consumer items such as automobiles, appliances and the like, there has been a move to replace metal parts with plastic based parts. This allows for lower weight, greater design flexibility and in some cases lower processing and assembly costs. For applications where the part is coated, this can present a problem because low cost commercial coating processes use electrostatic coating and electroplating techniques which require the substrate to be electrically conductive. Electrically conductive polymer composites have been developed wherein large amounts of conductive fillers, such as carbon based materials, are added to the polymer matrix to render the composition electrically conductive. The problem with these solutions is that large amounts of fillers can negatively impact some of the advantageous properties of the polymer matrices and can also add significant costs.

Carbon nanofibers which are prepared in the form of networks of fibers are conductive. Such carbon nanofiber networks are described in U.S. Pat. No. 5,846,509 and U.S. Pat. No. 5,594,060, both incorporated herein by reference. The networks are agglomerated and interconnected and it is difficult to wet the fibers out with polymers or polymer precursors. Thus, it has been a practice to grind the carbon nanofiber networks into a fine powder and disperse the powder into a polymer or polymer precursor. This requires relatively high loading to achieve conductivity.

Macrocyclic oligomers have been developed which, under reaction conditions, can form polymeric compositions with desirable properties such as strength, toughness, high gloss and solvent-resistance. Among preferred macrocylic oligomers are macrocyclic polyester oligomers such as those disclosed in U.S. Pat. No. 5,498,651, incorporated herein by reference. Such macrocyclic polyester oligomers have desirable properties in that they are excellent matrices for polymer composites because they exhibit low viscosities when compared to other polymers and precursors to polymers, which facilitate good impregnation and wet out in certain composite applications. Furthermore, such macrocyclic oligomers are easy to process using conventional processing techniques. The polymers prepared from macrocyclic oligomers prepare articles that are characterized by a unique combination of chemical, physical and electrical properties. In particular, they are chemically stable and display high impact strengths.

What is needed are polymeric compositions which are conductive yet which have relatively low loadings of conductive material. What is also needed is a conductive polymer composite wherein carbon nanofiber networks can be used without grinding them into powder and which can be used without destroying the carbon fiber network. It is also desired to prepare articles from such conductive polymer using conventional processes and equipment.

The invention is a composition comprising

a) a polymer matrix derived from a macrocyclic oligomer;

b) an agglomerated network of carbon nanofibers wherein the nanofibers are dispersed in the polymer matrix and the composition demonstrates a conductivity of 1×10⁻⁵ S/cm or greater.

In yet another embodiment the invention is a method of preparing a polymer matrix having dispersed therein a network of carbon nanofibers which comprises contacting one or more networks of carbon nanofibers with molten macrocyclic oligomer and a catalyst for polymerization of the macrocyclic oligomer under conditions that the macrocyclic oligomer polymerizes with the carbon nanofibers dispersed therein.

The compositions of the invention demonstrate excellent electric conductivity, toughness, heat resistance and ductility. The compositions also demonstrate excellent dispersion of carbon nanofibers in the polymer matrix. The macrocyclic oligomers demonstrate excellent wet out of the carbon nanofiber networks. The compositions of the invention also process to make various useful articles using conventional processes and equipment.

In general, the invention relates to conductive polymer compositions derived from macrocyclic oligomers. The polymer matrix is formed by polymerization of macrocyclic oligomers after the macrocyclic oligomers have undergone decyclization to form reactive groups which are capable of polymerization or through ring expansion polymerization. The carbon nanofibers are generally produced in the form of very thin long nanotubes in the form of a loosely associated network of individual fibers. By keeping the network intact, the fibers can serve to conduct electricity through the network and when dispersed in a polymeric matrix through the polymeric matrix. In one embodiment of the invention, a polyfunctional polymer which comprises a polymeric chain having at least two functional groups which are reactive with the decyclized macrocyclic oligomers is added to the composition. Preferably, this polymer has a low glass transition temperature. Preferably, the polymer is chosen, and the amount is chosen to give desired ductility properties. Preferably, such polymer composite exhibits a ductility increase of 50 percent or greater, more preferably 200 percent or greater and most preferably 500 percent or greater. Preferably, the ductility is 50 inch/lbs (279 cm/kg) or greater, more preferably 150 inch/lbs (838 cm/kg) or greater and most preferably 300 inch lbs (1680 cm/kg) or greater. Where the polyfunctional polymer exhibits a low glass transition temperature, the polymeric composite may exhibit two phases which are linked together through covalent bonds. One phase will comprise primarily the polymer derived from the macrocyclic oligomers, and the other phase will comprise primarily the low glass transition polymer phase. Under certain conditions, the polymer formed may have lower molecular weight than desired for certain applications. In one embodiment of the invention, the polymer composition further comprises a polyfunctional chain extending compound which functions to react with two or more terminal ends of a macrocyclic oligomer chain to therefore form higher molecular weight polymers in the polymeric matrix. Preferably, the molecular weight of the macrocyclic oligomer-based polymer is 40,000 or more (weight average molecular weight), more preferably 80,000 or more and most preferably 120,000 or more.

In another embodiment the polymer matrix may not be sufficiently elastomeric for desired use. In order to improve the toughness of the resulting polymer compositions, core shell rubbers may be added to the composition to improve the toughness. Generally, toughness is measured by measuring the dart impact according to ASTM D3763-99. Preferably, the toughness is exhibited by having a dart impact of 50 in lbs or greater, more preferably 150 in lbs or greater and most preferably 300 in lbs or greater.

The macrocyclic oligomers which may be used in this invention include any macrocyclic oligomers which can undergo polymerization under reasonable conditions to form a thermoplastic polymer matrix. As used herein, a macrocylic molecule means a cyclic molecule having at least one ring within its molecular structure that contains eight or more atoms covalently connected to form the ring. As used herein, an oligomer means a molecule that contains two or more identifiable structural repeat units of the same or different formula. A macrocyclic oligomer may also be a co-oligomer or multi-oligomer, that is an oligomer having two or more different structural repeat units within one cyclic molecule. The decyclization means herein the breaking of a cyclic ring structure to form a non-cyclic ring structure. In the context of this invention, such decyclization generally results in the formation of a compound having one or more, preferably two or more reactive functional groups through which polymerization can occur. In another embodiment the macrocyclic oligomer can undergo polymerization by ring expansion.

Preferably the macrocyclic oligomers comprise macrocyclic polycarbonates, polyesters, polyimides, polyetherimides, polyphenylene ether-polycarbonate co-oligomers, polyetherimide-polycarbonate co-oligomers and blends, compositions and co-oligomers prepared therefrom, more preferably the macrocyclic oligomer comprise macrocyclic polyesters, polycarbonates or polyphenylene ethers, blends, compositions or co-oligomers thereof, even more preferably the macrocyclic oligomer is a macrocyclic polyester. Preferably, the macrocyclic polyester oligomer contains a structural repeat unit corresponding to the formula 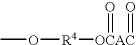
wherein R⁴ is separately in each occurrence alkylene, cycloalkylene, a mono or polyoxyalkylene group and A is separately in each occurrence a divalent aromatic or alicyclic group. Preferably A is a meta or para linked monocyclic aromatic or alicyclic groups. More preferably A is a C_{6 to 10} monocyclic aromatic or alicyclic group.

Preferably, R⁴ is a C₂₋₈ alkylene, or mono or polyoxyalkylene groups. Even more preferably, R⁴ is the residue of preferred macrocyclic polyester oligomers comprised of glycol terephthalates, isophthalates and mixtures thereof, and more preferred the macrocyclic oligomers comprising of 1,4-butylene terephthalate; 1,3-propylene terephthalate; 1,4-cyclohexylene dimethylene terephthalate, ethylene terephthalate, 1,2-ethylene 2,6-naphthalene dicarboxylate or macrocyclic co-oligomers comprising two or more of the listed macrocyclic oligomers.

The polymer derived from macrocyclic oligomers is present in the polymeric composition in an amount of 50 parts by weight or greater based on 100 parts by weight of the polymer composition, more preferably 65 parts or greater and most preferably 75 parts by weight or greater. The polymer derived from macrocyclic oligomers is present in the polymeric composition in an amount of 99 parts by weight or less based on 100 parts by weight of the polymer composition, even more preferably about 98 parts by weight or less, more preferably 95 parts or less and most preferably 80 parts by weight or less. Polymer composition as used herein refers to the entire weight of the prepared polymer composition, which includes organoclay carbon nanofibers and other auxiliary additives. Derived from in this context means that the resulting polymer was prepared from the recited reactant, in this context macrocyclic oligomer. Such polymers contain the residue of compounds from which they are derived. Residue as used herein means that the polymeric composition contains repeat units which come from the recited reactant, herein macrocyclic oligomer.

The polymeric matrix can have dispersed in it any conductive materials such as carbon nanotubes, carbon black, and carbon nanofibers and mixtures thereof. Because of the processing advantages of the macrocyclic oligomers, this invention is especially useful with high aspect ratio conductive materials and even more advantageous for use with networks of conductive fibers. Thus preferred conductive materials are networks of conductive fibers, especially dense associated networks of conductive materials. Among preferred carbon nanofibers are those disclosed in U.S. Pat. Nos. 4,391,787; 4,481,569; 4,497,788; 4,565,684; 5,024,818; 5,374,415; 5,389,400; 5,413,773; 5,424,126; 5,587,257; 5,594,060; 5,604,037; 5,814,408; 5,837,081; 5,846,509 and 5,853,865, all incorporated herein by reference. A class of preferred carbon nanofibers are available from Applied Sciences Inc., Cedarville Ohio, under the trademark and designation Pyrograf® III.

The carbon nanofibers used preferably have a largest length dimension of 10 microns or greater, more preferably 30 microns or greater and most preferably 50 microns or greater. Preferably the carbon nanofibers exhibit a largest length of 100 microns or less. Preferably, the carbon nanofibers have a diameter of 60 nanometers or greater, more preferably 70 or greater and most preferably 100 or greater. Preferably, the carbon nanofibers have a diameter of 200 nanometers or less and more preferably 150 nanometers or less. Preferably the carbon nanofibers exhibit an aspect ratio of 150 or greater and more preferably 200 or greater. Aspect ratio as used herein means the length of a fiber divided by the fiber diameter. The carbon fibers are present in the composition in sufficient amount to provide the desired levels of conductivity. Higher levels of carbon nanofibers give higher levels of electrical conductivity. The conductivity needs to be matched with the conductivity needed for the ultimate use. Preferably, the carbon nanofibers are present in an amount of 2 parts by weight or greater based on 100 parts by weight of polymer composition, more preferably 3 parts by weight or greater and most preferably 5 parts by weight or greater. Preferably, the carbon nanofibers are present in an amount of 20 parts by weight or less based on 100 parts by weight of polymer composition, more preferably 15 parts by weight or less and most preferably 5 parts by weight or less.

The composition may also comprise additional conductive material such as conductive carbon black. Any conductive material may also be included in the composition, such materials are well known to the skilled artisan.

For certain applications, the polymer compositions of the invention may not have adequate molecular weight. Therefore, to enhance the molecular weight of the polymers, a polyfunctional chain extending compound may be added to the composition so as to bond polymer chains together to increase the molecular weight. Any polyfunctional compound which has two or more functional groups which will react with functional groups formed as a result of decyclization or ring expansion of the macrocyclic oligomers may be used. Preferably, the functional groups comprise glycidyl ethers (epoxy compounds), isocyanate moieties, ester moieties, or active hydrogen-containing compounds. More preferably, the functional groups are isocyanate or epoxy, with epoxy functional groups being most preferred. Preferably, the polyfunctional compounds have a functionality of 2 to 4, more preferably 2 to 3 and most preferably 2. As used herein, the reference to functionality refers to the theoretical functionality. One skilled in the art would recognize that the actual average number of functional groups in a mixture of compounds may be less than theoretical due to incomplete conversion of compounds, by-products and the like. The amount of coupling agent added to the polymer should be an amount sufficient to achieve the desired molecular weight to give the desired properties. Preferably glycidyl ether based coupling agents are aliphatic or aromatic glycidyl ethers. Preferable isocyanate coupling agents include aromatic or aliphatic diisocyanates. More preferable isocyanate coupling agents include aromatic diisocyanates. Coupling agents are present in an amount of 0.25:1 or greater on a molar basis relative to the macrocyclic oligomer based on polymer endgroups relative to the macrocyclic oligomer, and most preferably 0.5:1 or greater.

In another embodiment the composition may further comprise the residue of a polyfunctional polymer having the residue of two or more functional groups having active hydrogen atoms wherein the polyfunctional polymer is bonded to the polymer derived from the macrocyclic oligomers. Polyfunctional used herein means that there are at least two functional groups or more present, preferably there are 2 to 4 functional groups, more preferably 2 to 3 functional groups and most preferably 2 functional groups for each polymer chain. Preferably, the polymers chosen such that the polymer has a glass transition temperature significantly lower than the glass transition temperature of the polymer derived from the macrocyclic oligomers. Preferably, the polyfunctional active hydrogen-containing polymer is chosen to improve the ductility of the polymeric composition prepared. Preferably, the polymer has a weight average molecular weight 1,000 or greater, more preferably 5,000 or greater and most preferably 10,000 or greater. Preferably, the polyfunctional active hydrogen-containing polymer has a molecular weight 50,000 or less, more preferably 30,000 or less and most preferably 20,000 or less. The polyfunctional active hydrogen-containing polymer can contain any backbone which achieves the desired results of this invention. Preferably, the backbone is an alkylene backbone, cycloalkylene backbone, or a mono or polyoxyalkylene-based backbone. A preferred class of backbones is polyoxyalkylene-based backbone. Preferably, the alkylene groups are C₂₋₄ alkylene groups, i.e, ethylene, propylene or butylene or mixtures thereof. In the event that a mixture of alkylene groups are used, the alkylene groups can be arranged in blocks of similar alkylene groups or arranged in a random fashion. Preferred active hydrogen functional groups are amine or hydroxyl groups, with hydroxyl groups being most preferred. The residue of the polyfunctional polymer containing functional groups having active hydrogen atoms is present in amount of 5 parts by weight per hundred parts by weight of the polymer present in the composition or greater, more preferably 10 parts by weight or greater and most preferably 15 parts by weight or greater. The residue of the polyfunctional polymer containing functional groups having active hydrogen atoms is present in an amount of 40 parts by weight per hundred parts by weight of the polymer present in the composition or less, more preferably 30 parts by weight or less and most preferably 25 parts by weight or less. Preferably, the polyfunctional polymer having active hydrogen-containing functional groups is a polyether polyol or polyester polyol.

In yet another embodiment of the invention, the composition may further comprise a core shell rubber to improve the toughness of the polymer composition. Any core shell rubber known to those skilled in the art may be added to the composition. Preferably, the core shell rubber is a functionalized core shell rubber having functional groups on the surface of a core shell rubber. Any functional group which reacts with the functional groups derived from decyclized macrocyclic oligomers or which can react by ring expansion with the macrocyclic oligomers may be used. Preferably, the functional groups comprise glycidyl ether moieties or glycidyl acrylate moieties. Preferably, the composition comprises a sufficient amount of core shell rubber to improve the toughness of the polymeric composition.

The core shell rubber is present in a sufficient amount such that the rubber core from the core shell rubber modifier is present in 5 parts per weight or greater based on 100 parts by weight of the polymeric composition, preferably 10 parts or greater and most preferably 15 parts or greater. The core shell rubber is present in sufficient amount such that the rubber core from the core shell rubber modifier is present in 35 parts per weight or less based on 100 parts by weight of the polymeric composition, preferably 30 parts or less and most preferably 25 parts or greater less.

Preferably, the core shell rubber has a surface which contains 10 percent by weight or less of a functional group in the shell, more preferably 5 percent by weight or less. Preferably, the core shell rubber has a surface which contains 0 percent by weight or greater of a functional group in the shell, more preferably 0.5 percent by weight or greater. Percent by weight in reference to functional group on the shell is based upon weight fraction of functional monomer in the shell phase.

The composition of the invention is prepared by contacting molten macrocyclic oligomer, conductive fibers and a catalyst for the polymerization of the macrocyclic oligomers. The macrocylcic oligomer and the conductive fibers can be contacted and then heated to a temperature at which the macrocyclic oligomer is molten. The catalyst is added at the same time the oligomers and carbon and fiber are contacted or after the mixture is heated to melt the oligomers. If the catalyst is added before melting the oligomers, then the temperature at which the oligomer is melted must be below the temperature at which substantial oligomer polymerization occurs in the presence of the chosen catalyst. The materials are preferably contacted with mixing to aid dispersion of the components. Alternatively, the macrocyclic oligomer can be heated to a temperature at which it is molten and then contacted with the conductive fibers and the catalyst. After the oligomer is melted and the components mixed, the mixture is heated to a temperature at which the oligomer polymerizes. The molten cylic oligomer fills the interstitial spaces between the fibers and polymerize in place when exposed to catalyst thereby forming a polymeric matrix around the fibers. Depending upon the functional groups contained in the macrocyclic oligomers, the catalyst will be selected for the appropriate macrocyclic oligomer. The catalyst is added and the composition are preferably mixed for a period of time to disperse the catalyst through the mixture. Thereafter, the mixture is exposed to conditions to raise the mixtures temperature to the temperature at which the macrocyclic oligomers undergo polymerization. The selection of the catalysts is driven by the nature of the macrocyclic oligomer, one skilled in the art would recognize suitable catalysts for the various macrocyclic oligomers. In a preferred embodiment, the macrocylic oligomer is an ester containing macrocyclic oligomer. In this embodiment, tin or titanate-based transesterification catalyst may be used. Examples of such catalysts are described in U.S. Pat. No. 5,498,651 and U.S. Pat. No. 5,547,984, the disclosures of which are incorporated herein by reference. Catalysts employed in the invention are those that are capable of catalyzing a transesterification polymerization of a macrocyclic oligomer. One or more catalysts may be used together or sequentially. As with state-of-the-art processes for polymerizing macrocyclic oligomers, organotin and organotitanate compounds are the preferred catalysts, although other catalysts may be used.

Illustrative examples of classes of tin compounds that may be used in the invention include monoalkyltin hydroxide oxides, monoalkyltinchloride dihydroxides, dialkyltin oxides, bistrialkyltin oxides, monoalkyltin trisalkoxides, dialkyltin dialkoxides, trialkyltin, alkoxides, tin compounds having the formula 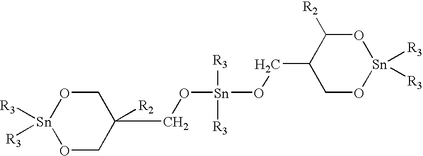
and tin compounds having the formula 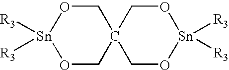
wherein R₂ is a C₁₋₄ primary alkyl group, and R₃ is C₁₋₁₀ alkyl group.
Specific examples of organotin compounds that may be used in this invention include dibutyltin dioxide, 1,1,6,6-tetra-n-butyl-1,6-distanna-2,5,7-10-tetraoxacyclodecane, n-butyltin chloride dihydroxide, di-n-butyltin oxide, dibutyltin dioxide di-n-octyltin oxide, n-butyltin tri-n-butoxide, di-n-butyltin di-n-butoxide, 2,2-di-n-butyl-2-stanna-1,3-dioxacycloheptane, and tributyltin ethoxide. See, for example., U.S. Pat. No. 5,348,985 to Pearce et al. In addition, tin catalysts described in U.S. Ser. No. 09/754,934 (incorporated by reference below) may be used in the polymerization reaction.

Titanate compounds that may be used in the invention include titanate compounds described in U.S. Ser. No. 09/754,943 (incorporated by reference below). Illustrative examples include tetraalkyl titanates (for example, tetra(2-ethylhexyl) titanate, tetraisopropyl titanate, and tetrabutyl titanate), isopropyl titanate, titanate tetraalkoxide. Other illustrative examples include (a) titanate compounds having the formula 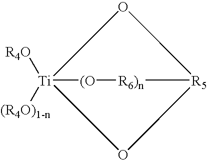
wherein each R₄ is independently an alkyl group, or the two R₄ groups taken together form a divalent aliphatic hydrocarbon group; R₅ is a C₂₋₁₀ divalent or trivalent aliphatic hydrocarbon group; R₆ is a methylene or ethylene group; and n is 0 or 1, (b) titanate ester compounds having at least one moiety of the formula 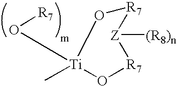
wherein each R₇ is independently a C₂₋₃ alkylene group; Z is O or N; R₈ is a C₁₋₆ alkyl group or unsubstituted or substituted phenyl group; provided when Z is O, m-n-0, and when Z is N, m=0 or 1 and m+n=1, and (c) titanate ester compounds having at least one moiety of the formula 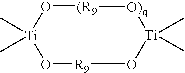
wherein each R₉ is independently a C₂₋₆ alkylene group; and q is 0 or 1.

The catalyst level should be the lowest level that permits rapid and complete polymerization, and which produces high molecular weight polymer. The mole ratio of transesterification catalyst to macrocyclic oligomer can range from 0.01 mole percent or greater, more preferably from 0.1 mole percent or greater and more preferably 0.2 mole percent or greater. The mole ratio of transesterification catalyst to macrocylic oligomer is from 10 mole percent or less, more preferably 2 mole percent or less, even more preferably 1 mole percent by weight or less and most preferably 0.6 mole percent or less.

The transesterification or polymerization reaction preferably takes place at a temperature at which decyclization and polymerization of the marcrocyclic proceeds at a reasonable pace and below a temperature at which the polymer undergoes decomposition. Such temperatures are well known to the skilled artisan.

The transesterification or polymerization reaction preferably takes place at a temperature of 150° C. or greater, more preferably 170° C. or greater and most preferably 190° C. greater. Preferably, the polymerization temperature takes place 300° C. or less, more preferably 250° C. or less, even more preferably 230° C. or less and most preferably 210° C. or less.

The polyfunctional active hydrogen-containing polymer can be added just prior to introduction of the catalyst for polymerization. The presence of the catalyst for polymerization of the macrocyclic oligomer and/or elevated temperatures are sufficient to drive the reaction of the polyfunctional active hydrogen-containing polymer to react with the macrocylic oligomers.

The polymerization step is preferably conducted under an inert atmosphere such as in the presence of dry nitrogen or argon.

After completion of polymerization, a polyfunctional chain extending agent as described hereinbefore may be contacted with the composition. The composition can thereafter be exposed to temperatures at which the chain extension agent reacts with the functional ends of the polymer derived from macrocylic oligomers. No additional catalyst is required and elevated temperatures as described hereinbefore are used for the polymerization.

The core-shell modifier is preferentially added after the polymerization is complete, in a high shear environment such as an extruder.

The resulting polymeric composition may be used to prepare molded articles. Such articles can be molded by techniques commonly known in the art, for instance, injection molding, compression molding, thermoforming, blow molding, resin transfer molding, preparation of composites using flame-spray technology such as disclosed in U.S. Patent Application, commonly owned and contemporaneously filed patent application having a Ser. No. 60/435,170 and the title of POLYMERIZED MACROCYCLIC OLIGOMER NANOCOMPOSITE COMPOSITIONS, incorporated herein by reference. The polymeric composites of the invention may further contain other additives commonly used molded applications such as stabilizers, color concentrates and the like.

Generally, the articles are molded by exposing the compositions of the invention to temperatures at which they are molten and injecting or pouring them into a mold and then applying pressure to form the appropriate shape of the part. The compositions of the invention can be used to make high heat body panels parts used in automotive applications.

### SPECIFIC EMBODIMENTS

The following examples are included for illustrative purposes only and are not intended to limit the scope of invention. Unless otherwise stated, all parts and percentages are by weight.

### EXAMPLE 1

1.5 g of graphite nanotubes, a loosely associated agglomeration of fibers, (Pyrograf III VGCF) were placed in a 100 ml two neck round bottom flask along with 28.5 g of dry polybutylene terephthalate cylic oligomers (available from Cyclics Corporation). The mixture was dried at 90° C. at 2 mm HG for 16 hours. The mixture was evacuated/purged with nitrogen three times, then heated at 160° C. with agitation from an overhead stirrer for 80 minutes. Once molten and well mixed 0.13 mol percent of Sn was added in the form of butyl tin chloride di hydroxide. The mixture was allowed to mix for 14 minutes. The flask was transferred to a 250° C. bath and the material was heated with agitation from 20 minutes, yielding a polybutylene terephthalate/graphite composite having a 5 percent by weight loading of graphite. The composite was cooled to room temperature and ground into pellets.

### EXAMPLES

In Example 2 the procedure of Example 1 was performed wherein 90 parts by weight of a mixture of polybutylene terephthalate cyclic oligomers and butyl tin chloride di hydroxide (mole percent of tin) and 10 parts of graphite nanotubes were contacted and heated for 53 minutes at 160° C. and then for 10 minutes at 250° C.

In Example 3 the procedure of Example 1 was performed wherein 90 parts by weight of polybutylene terephthalate cylic oligomers and 10 parts of graphite nanotubes were contacted and heated for 70 minutes at 160° C. A sufficient amount to provide 0.13 mole percent of butyl tin chloride di hydroxide was added and the mixture was mixed at 160° C. for ten minutes. The temperature of the mixture was heated to 250° C. and mixed at this temperature for 15 minutes.

In Example 4 the procedure of Example 3 was performed wherein 80 parts by weight of polybutylene terephthalate cylic oligomers and 20 parts of graphite nanotubes were contacted and heated for 79 minutes at 160° C. A sufficient amount of catalyst to provide 0.15 mole percent of butyl tin chloride di hydroxide was added and the mixture was mixed at 160° C. for fifteen minutes. The mixture was heated to 250° C. and stirred at this temperature for 15 minutes.

In Example 5 the procedure of Example 2 was performed wherein 80 parts by weight of a mixture of polybutylene terephthalate cylic oligomers and butyl tin chloride di hydroxide (mole percent of tin) and 20 parts of graphite nanotubes were contacted and heated for 51 minutes at 160° C. and then for 10 minutes at 250° C.

In Example 6 the procedure of Example 2 was performed wherein 95 parts by weight of a mixture of polybutylene terephthalate cylic oligomers and butyl tin chloride di hydroxide (mole percent of tin) and 5 parts of graphite nanotubes were contacted and heated for 58 minutes at 160° C. and then for 10 minutes at 250° C.

Samples as described in Examples 1 to 5 were injection molded into ASTM type 1 tensile bars and these samples were tested from electrical conductivity. A sample comprising 4 parts of Example 2 and 1 part of Example 6 was tested for conductivity and it exhibited a conductivity of 4.06×10⁻⁵ S/cm (64500 ohms).

What is claimed is:

1. A composition comprising
a) a polymer derived from a macrocyclic oligomer; and
b) a network of loosely associated nanofibers wherein the carbon nanofibers are dispersed in the polymer matrix and the composition demonstrates a conductivity of 1×10⁻⁵ S/cm.

2. Compositions according to claim 1 which further comprise a polyfunctional chain extending agent.

3. Compositions according to claim 1 which further comprise a core shell rubber.

4. Compositions according to claim 3 wherein the core shell rubber has functional groups on the surface of a core shell rubber.

5. Compositions according to claim 1 which further comprise a polyfunctional active hydrogen-containing polymer.

6. Compositions according to claim 1 which comprise
a) from about 50 to about 98 parts per hundred by weight of the composition of polymer matrix, and
b) from about 2 to about 20 parts per hundred parts by weight of the composition of carbon nanofibers.

7. Compositions according to claim 1 wherein the aspect ratio of the carbon nanofibers is 150 or greater.

8. A composition according to claim 1 wherein the polymer matrix comprises a polyester derived from macrocyclic oligoesters.

9. A process according to any one of claims 1 to 8 for the preparation of a polymer matrix having dispersed therein a network of associated carbon nanofibers which comprises contacting a network of carbon nanotubes with molten macrocyclic oligdmer and a catalyst for polymerization of the macrocyclic oligomer under conditions that the macrocyclic oligomer cyclizes and polymerizes with the carbon nanofibers dispersed therein.

10. The process of claim 9 wherein the temperature of the reaction mixture is 150° C. to about 300° C.

11. A molded article comprising the composition of any one of claims 1 to 8.
